(19) United States
(12) Patent Application Publication
(10) Pub. No.: US 2025/0067119 A1
(43) Pub. Date: Feb. 27, 2025

(54) APPARATUS AND METHOD TO ADJUST VANE ANGLE OF DOUBLE FABRIC SHADING BY RESTRAINT OF FACING

(71) Applicant: COMFORTEX CORPORATION, Maplewood, NY (US)

(72) Inventors: Richard D. Watkins, Lake Luzerne, NY (US); James L. Barss, Porter Corners, NY (US); Yetman Liu, Albany, NY (US); Thomas J. Marusak, Loundonville, NY (US)

(21) Appl. No.: 18/724,731

(22) PCT Filed: Dec. 27, 2022
(86) PCT No.: PCT/US2022/082396

§ 371 Date: Jun. 27, 2024

Related U.S. Application Data
(60) Provisional application No. 63/266,107, filed on Dec. 29, 2021.

(51) Int. Cl. E06B 9/42; E06B 9/24; E06B 9/34

(52) U.S. Cl. CPC E06B 9/42; E06B 9/34; E06B 2009/2435

(57) ABSTRACT

Embodiments of the present disclosure provide an apparatus and method to adjust the angle of a double fabric shading by restraint of a facing in the double fabric shading. The apparatus may include a friction surface configured to selectively restrain movement of a first facing of a window shading. The first facing is coupled to a fabric supply roller of the window shading at a first position on an outer surface of the fabric supply roller and coupled to a second facing of the window shading through a plurality of vanes extending between the first facing and the second facing. Rotating the fabric supply roller of the window shading to extend or retract the second facing, while restraining movement of the first facing with the friction surface, adjusts an angular position of the plurality of vanes.

### BACKGROUND

### 1. Technical Field

The disclosure relates generally to window shadings, and more particularly, to a system and method to adjust the angle of double fabric shadings by restraining one facing of the double fabric shading.

### 2. Background Art

As depicted in FIGS. 1-3, conventional window shading assemblies may include a double-panel shading having a first facing 102 and a second facing 104 and a plurality of vanes 106 extending therebetween. It will be appreciated that as used herein, a “facing” may be in the form of a sheet or panel or other type of support element for supporting the vanes, such as a support element or “support” having a distinct width, e.g., similar to the width of the vanes. A shading element 108 which includes first and second facings 102, 104, can be wound about a roller 110 for selectively rolling and unrolling shading element 108. Roller 110 can be positioned within a headrail or casing 112 so that shading element 108, when rolled about roller 110 in a retracted position, is substantially contained within casing 112. Shading element 108 can include, at a bottom end opposite the end of shading element 108 coupled to roller 110, a bottom rail 114 for receiving first and second facings 102, 104, in addition to defining a lower vertical position of shading element 108. Bottom rail 114 can also include, e.g., grooves formed therein at any desired lateral position thereof. Roller 110 can be mounted to a particular wall, window frame, architectural fixture, etc., in a conventional manner, e.g., by way of endcaps or brackets 113. Each facing 102, 104, in shading element 108 can be composed of a high transparency material, with vanes 106 being composed of a less translucent fabric and spaced apart at even and/or uneven spatial intervals. Shading element 108 can be mounted to roller 110 such that when roller 110 is rotated to a first position, first and second facings 102, 104 can hang from opposing front and rear sides of the assembly.

As shown in FIG. 2, first and second facings 102, 104 of a window shading 100 can be spaced apart with vanes 106 extending between first and second facings 102, 104, thus providing maximum view-through as shown in FIG. 2. When roller 110 is rotated in a first direction by an actuating device (e.g., a cord 118), movement of roller 110 can raise second facing 104 (which may face externally toward, e.g., a window), relative to first facing 102 (which may face internally toward, e.g., the inside of the room where the shading is hung). The first effect of such rotation is to adjust the angle of vanes 106 with respect to first and second facings 102, 104, and thereby bring first and second facings 102, 104 closer together with vanes 106, and obstructing or blocking an observer's view through first and second facings 102, 104. Further rotation of roller 110 in the same direction with cord 118 can then roll both facings 102, 104 onto roller 110, lifting shading element 108 from the window area as in a conventional roller shade. Unrolling the shading element 108 of window shading 100 again can reverse this process. For example, first and second facings 102, 104 can be lowered to cover the window area, then, with a final partial turn of roller 110, first and second facings 102, 104 can be shifted with respect to each other such that vanes 106 are tilted to provide view-through. Bottom rail 114 can act to maintain the facings 102, 104 in smooth, level planes, by tension, and can induce vanes 106 to flex as needed for their tilting by providing additional weight.

Double fabric shading assemblies, such as window shading 100, can only be opened when facings 102, 104 are in a fully lowered (also known as fully deployed or fully unrolled) position. In such a position, the further unrolling rotation of roller 110 separates facings 102, 104 from each other to adjust the angle of connecting vanes 106 between facings 102, 104. However, further adjustment of vane angle is impossible at any partially deployed (i.e., non-fully deployed) position of window shading 100. In these partially deployed positions, forward or backward rotation of roller 110 will simply adjust the position of bottom rail 114 relative to casing 112.

### BRIEF SUMMARY

Aspects of the disclosure provide an apparatus including: a fabric supply roller having an outer surface; a window shading including: a first facing coupled to the fabric supply roller at a first position on the outer surface of the fabric supply roller; a second facing coupled to the fabric supply roller at a second position on the outer surface of the fabric supply roller; and a plurality of vanes extending between the first facing and the second facing; and a friction surface positioned to selectively engage the first facing and restrain substantially downward movement of the first facing during substantially downward movement of the second facing, and to allow substantially upward movement of the first facing during substantially upward movement of the second facing.

In some implementations, the friction surface is on a friction roller.

In some implementations, the friction roller is operatively coupled to the fabric supply roller.

In some implementations, wherein the friction surface is selectable between: a first operative state permitting the first facing to move freely; and a second operative state restraining substantially downward movement of the first facing.

In some implementations, the friction surface is on a friction roller configured to rotate freely in the first operative state and remain stationary in the second operative state.

In some implementations, the friction surface is moveable between: a first position in which the friction surface is disengaged from the first facing to permit the first facing to move freely; and a second position in which the friction surface engages the first facing to restrain substantially downward movement of the first facing.

In some implementations, the friction surface is mounted on a rotatable member operatively coupled to the fabric supply roller.

In some implementations, the apparatus further includes a locking mechanism coupled to the friction surface and the rotatable member, wherein the locking mechanism selectively prohibits rotation of the rotatable member.

In some implementations, the locking mechanism is electrically actuated or mechanically actuated.

In some implementations, the locking mechanism includes a shuttle and track lock.

In some implementations, the friction surface is operationally independent of the rotatable member and the fabric supply roller.

In some implementations, the first facing and the second facing are adjustable between a fully retracted position, a fully deployed position, and a plurality of partially deployed positions, wherein the friction surface is configured to selectively restrain movement of the first facing from one of the plurality of partially deployed positions.

In some implementations, the apparatus further includes a motor operatively coupled to the fabric supply roller, wherein the motor is configured to incrementally rotate the fabric supply roller to move the second facing from one of the plurality of partially deployed positions while the friction surface restrains movement of the first facing.

In some implementations, a material composition of the friction surface imparts a first frictional force on the first facing during retraction of the first facing onto the fabric supply roller and imparts a second frictional force on the first facing during extension of the first facing from the fabric supply roller, wherein the second frictional force is greater than the first frictional force.

In some implementations, the friction surface is connected to a sprag clutch operatively coupled to the friction surface, and the sprag clutch is configured to selectively prohibit rotation of the friction surface while in contact with the first facing to restrain downward movement of the first facing during rotation of the fabric supply roller.

In some implementations, the first facing is between the friction surface and the second facing, and the second facing does not contact the friction surface.

Further aspects of the disclosure provide an apparatus including: a friction surface configured to selectively restrain movement of a first facing of a window shading, the first facing being coupled to a fabric supply roller of the window shading at a first position on an outer surface of the fabric supply roller, and coupled to a second facing of the window shading through a plurality of vanes extending between the first facing and the second facing, wherein rotating the fabric supply roller of the window shading to extend or retract the second facing, while restraining movement of the first facing with the friction surface, adjusts an angular position of the plurality of vanes.

In some implementations, the friction surface is selectable between: a first operative state permitting the first facing to move freely; and a second operative state restraining substantially downward movement of the first facing.

In some implementations, the friction surface is on a friction roller configured to rotate freely in the first operative state and remain stationary in the second operative state.

In some implementations, the friction surface is moveable between: a first position in which the friction surface is disengaged from the first facing to permit the first facing to move freely; and a second position in which the friction surface engages the first facing to restrain substantially downward movement of the first facing.

In some implementations, the friction surface is mounted on a rotatable member operatively coupled to the fabric supply roller.

In some implementations, the apparatus further includes a locking mechanism coupled to the friction surface and the rotatable member, wherein the locking mechanism selectively prohibits rotation of the rotatable member.

Still further aspects of the disclosure provide a method for operating a window shading, the method including: engaging a first facing of the window shading with a friction surface to restrain movement of the first facing, the first facing being coupled to a fabric supply roller of the window shading at a first position on an outer surface of the fabric supply roller, and coupled to a second facing of the window shading through a plurality of vanes extending between the first facing and the second facing; and rotating the fabric supply roller of the window shading to extend or retract the second facing while engaging the first facing with the friction surface to adjust an angular position of the plurality of vanes.

In some implementations, the method further includes moving the first facing and the second facing of the window shading to one of a plurality of partially deployed positions before engaging the first facing of the window shading with the friction surface.

In some implementations, the method further includes moving the friction surface to a first position adjacent the roller in which the friction surface is disengaged from the first facing to permit of the first facing to move around the roller, wherein engaging the first facing with the friction surface includes moving the friction surface to a second circumferential position between the roller and the second facing.

In some implementations, the method further includes incrementally extending the second facing from the roller while engaging the first facing of the window shading with the friction surface to incrementally adjust an angular orientation of the plurality of vanes.

In some implementations, the method further includes positioning the first facing and the second facing of the window shading in one of a plurality of partially deployed positions with respect to the fabric supply roller before engaging the first facing of the window shading with the friction surface.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a side view of a window shading.

FIG. 2 shows a side view of the window shading with two facings in an open position.

FIG. 3 shows a side view of the window shading with two facings in a closed position.

FIG. 4 shows a cross-sectional view of an apparatus for adjusting the vane angle of a double fabric window shading, with the window shading in a fully deployed position, according to embodiments of the disclosure.

FIG. 5 shows a perspective view of an apparatus for adjusting the vane angle of a double fabric window shading, with the window shading in a fully deployed position, according to embodiments of the disclosure.

FIG. 6 shows a cross-sectional view of an apparatus for adjusting the vane angle of a double fabric window shading, with the window shading in a fully retracted position, according to embodiments of the disclosure.

FIG. 7 shows a perspective view of an apparatus for adjusting the vane angle of a double fabric window shading, with the window shading in a fully retracted position, according to embodiments of the disclosure.

FIG. 8 shows a cross-sectional view of an apparatus for adjusting the vane angle of a double fabric window shading, with the vanes adjusted in a partially deployed position, according to embodiments of the disclosure.

FIG. 9 shows a perspective view of an apparatus for adjusting the vane angle of a double fabric window shading, with the vanes adjusted in a partially deployed position, according to embodiments of the disclosure.

FIG. 10 shows a cross-sectional view of an apparatus for adjusting the vane angle of a double fabric window shading, with the window shading in a partially deployed position, according to embodiments of the disclosure.

FIG. 11 shows a perspective view of an apparatus for adjusting the vane angle of a double fabric window shading, with the window shading in a partially deployed position, according to embodiments of the disclosure.

FIG. 12 shows a cross-sectional view of a locking mechanism in the form of a sprag clutch coupled to a friction roller, according to embodiments of the disclosure.

FIG. 13 shows a cross-sectional view of a locking mechanism in the form of a shuttle and track lock coupled to a friction roller, according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

Embodiments of the present disclosure provide an apparatus and method for adjusting the vane angle of a double fabric window shading by restraint of one facing. Embodiments of the disclosure may include a friction surface that selectively restrains movement of a first facing (e.g., a front facing) of the window shading. The first facing is coupled to a fabric supply roller of the window shading at a first position on an outer surface of the fabric supply roller. The first facing is also connected to a second (e.g., rear facing) of the window shading through a plurality of vanes extending between the first and second facings. Rotating the fabric supply roller of the window shading (e.g., to extend or retract the second facing), while restraining movement of the first facing with the friction surface, adjusts the angular position of the vanes. In further implementations, the apparatus may include the fabric supply roller, the window shading (including the first facing, second facing, and the plurality of vanes), and the friction surface for selectively engaging the first facing. Embodiments of the disclosure also provide methods to adjust the vane angle of a double fabric shading via friction surface for selectively engaging the first facing of the double fabric window shading. Embodiments of the disclosure differ from conventional double fabric window shadings, e.g., by enabling angular vane adjustment before the shading is fully deployed from a roller.

It will be appreciated that a window shading is an example setting where an apparatus and method according to the disclosure may be applied. It will further be appreciated that in the illustrated embodiments of a window covering in the form of a window shading, light transmission through the shading is achieved by moving one of the two facings relative to the other to re-orient the vanes in a vertical direction to provide a closed configuration (in which the vanes are blocking light transmission through the front and rear facings). However, in a different configuration in which the upper ends of the vanes are coupled to the front facing, the front facing may rotate upward relative to the rear facing, and in this case the front panel of the shading functions as the “second facing,” and the rear panel of the shading functions as the “first facing.” Thus, it will be appreciated that directional references are illustrative and to be taken in context of the example shading being described, and to be understood relative to other directional references in each example.

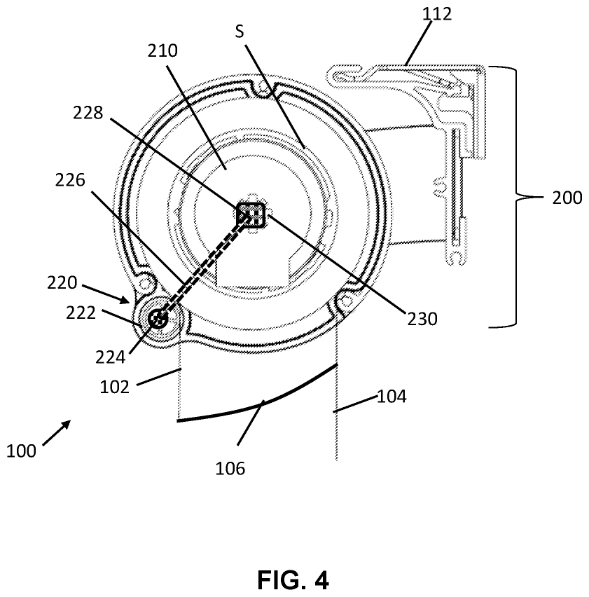

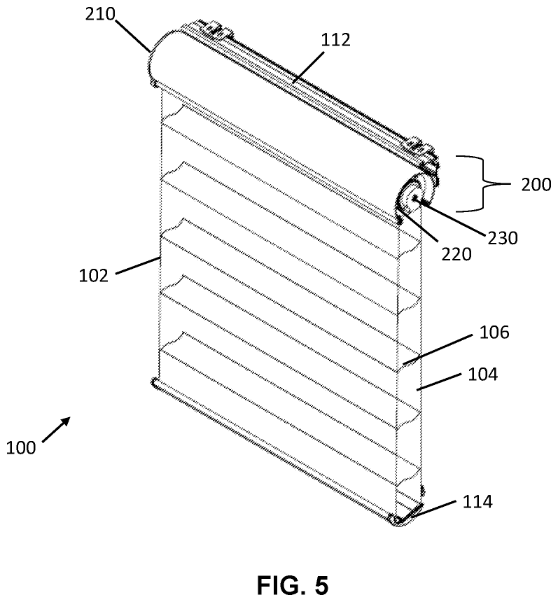

Referring to FIGS. 4 and 5, an apparatus 200 to adjust vane angle in window shading 100 is shown. FIG. 4 provides a cross-sectional view and FIG. 5 provides a perspective view of apparatus 200. As discussed elsewhere herein, window shading 100 can include first and second facings 102, 104. Facings 102, 104 are coupled to apparatus 200 opposing front and rear sides of bottom rail 114 (FIG. 5). Although first and second facings 102, 104 are identified herein such that the “front” faces leftward and the “rear” faces rightward, it is understood that these orientations may be reversed and/or modified based on an intended application of apparatus 200. Apparatus 200 may be coupled to and operably associated with first and second facings 102, 104, and in the example shown apparatus 200 may be located within casing 112 and/or otherwise coupled to a fabric supply roller 210 of window shading 100.

Apparatus 200 may include, e.g., fabric supply roller 210 having an outer surface S (FIG. 4) that is shaped to receive first and second facings 102, 104 of window shading 100 thereon. First facing 102 may be coupled to fabric supply roller 210 at a first position on outer surface S, and second facing 104 may be coupled to fabric supply roller 210 at a second position on outer surface S. The positions may be diametrically opposed on roller 210. Vanes 106, as discussed herein, extend between first facing 102 and second facing 104.

Embodiments of apparatus 200 do not apply the above-noted conventional dynamics of facing 102, 104 actuations in window shading 100. Rather than only allowing facings 102, 104 to move apart when fabric supply roller 210 fully deploys facings 102, 104 (i.e., when of the fabric is paid off from the roller), embodiments of apparatus 200 apply the weight of bottom rail 114 (FIG. 5) with a restraint of first facing 102 to allow facings 102, 104 to separate at multiple positions to open vanes 106. When one facing (e.g., first facing 102) is restrained, the other facing (e.g., second facing 104) can translate substantially downward relative to first facing 102 as it remains stationary. When this happens, vanes 106 will rotate to an open orientation and bottom rail 114 similarly rotates to a substantially horizontal orientation. Embodiments of the disclosure provide this function using a friction surface 220 that selectively engages first facing 102 as it is deployed from or retracted onto fabric supply roller 110.

Apparatus 200 includes friction surface 220 positioned to selectively engage first facing 102. The term “selective engagement,” as used herein, refers to any physical engagement of first facing 102 to friction surface 220 that causes friction surface 220 to impart frictional force against first facing 102 when it extends or retracts from fabric supply roller 210. Friction surface 220, via selective engagement, may be selectable between a first operative state in which friction surface 220 engages first facing 102 and a second operative state in which friction surface 220 is disengaged from first facing 102. Friction surface 220 optionally may include a friction roller 222 configured to move with respect to window shading 100. In this case, friction roller 222 may selectively engage first facing 102 by moving into contact with, or out of contact with, first facing 102. In further implementations, friction surface 220 may be permanently in contact with first facing 102 but may only selectively apply friction thereto, e.g., by selectively being non-rotatable or rotatable with extension or retraction motion by first facing 102.

In still further implementations, friction surface 220 may be a surface having a material composition that imparts a first frictional force on first facing 102 when first facing 102 retracts onto fabric supply roller 210 but imparts a second, greater frictional force on first facing 102 when first facing 102 is extended from fabric supply roller 210. Friction surface 220 thus may be formed of one or more directionally asymmetric friction materials including, e.g., “z-machine” and “s-machine” surfaces formed of layered deformable and non-deformable materials. Friction surface 220, when disengaged from first facing 102 may have substantially no effect on the ability of second facing 104 to extend from or retract onto fabric supply roller 110. It is understood that in alternative implementations, friction surface 220 may instead engage second facing 104, and that in such cases friction surface 220 may not engage first facing 102.

Friction surface 220 may be configured to impart friction against first facing 102 only in one direction of travel. For instance, when friction surface 220 engages first facing 102 during any substantially downward movement (e.g., extension motion) of second facing 104, it may restrain any corresponding substantially downward movement of first facing 102. By contrast, friction surface 220 may allow substantially upward movement (e.g., retracting movement) of first facing 102 during corresponding substantially upward movement of second facing 104. The direction-dependent action of friction surface 220 on first facing 102 may be achieved via a variety of mechanisms and methodologies, and examples of such mechanisms and methodologies are described in further detail elsewhere herein. Thus, friction surface 220 may be selectable between a first operative state which permits first facing 102 to move freely, and a second operative state in which friction surface 220 restrains any substantially downward movement of first facing 102.

FIG. 4 provides an example of how friction surface 220 may selectively engage first facing 102 to selectively impart friction against first facing 102. In this example, friction surface 220 may be a friction roller 222 structured to rotate in clockwise and counterclockwise directions. First facing 102 may pass over the surface of friction roller 222, thus causing friction roller 222 to rotate in a direction corresponding to the tangential movement of first facing 102 across friction surface 220. For instance, friction roller 222 may rotate clockwise when first facing 102 extends in a substantially downward direction and friction roller 222 may rotate counterclockwise when first facing 102 retracts in a substantially upward direction. Friction surface 220, however embodied, may be coupled to a locking mechanism 224 which selectively prohibits rotation in either or both clockwise and counterclockwise directions. Locking mechanism 224 may include any currently known or later developed mechanically and/or electrically actuated device for preventing movement in predefined directions, e.g., a ratchet, brake, lock, one way bearing, latch, hinge, clutch, etc. Locking mechanism 224 may engage friction surface 220 (including, e.g., friction roller 222) by a variety of methods. For instance, locking mechanism 224 can be activated by motion of first facing 102 over friction surface 220. In the case where friction surface 220 is on friction roller 222, movement of first facing 102 also drives movement of friction roller 222.

Locking mechanism 224, e.g., in the form of a ratchet, cord loop lock, etc., may sense when the direction of travel of first facing 102 reverses from lowering to raising and lowering again. In this case, locking mechanism 224 may lock friction surface 220 (e.g., by engaging friction surface 220 with first facing 102 or by preventing further rotation of friction roller 222). In further examples, locking mechanism 224 can include gears, belts, and/or other devices for engaging friction surface 220 with first facing 102 under predefined conditions (e.g., simply sensing movement in a particular direction and/or a change in the direction that first facing 102 moves). In still further examples, locking mechanism 224 may be an assembly including an electronically activated solenoid coupled to a ratcheting mechanism. In this case, the solenoid can be energized (e.g., via a corresponding electrical connection) to place locking mechanism 224 in a locked state. In a more specific example, the solenoid may be a “bi-stable” component requiring only a momentary electronic signal, or sensed mechanical action of first facing 102, to change the ratcheting mechanism from its unlocked state to its locked state and vice versa (e.g., to reduce power consumption).

To further control friction surface 220, friction roller 222 (where applicable), and/or locking mechanism 224, a mechanical coupling 226 (e.g., shaft, gear assembly, etc.) may couple a drive mechanism 228 to one or more of friction surface 220, friction roller 222 (where applicable), and/or locking mechanism 224. Drive mechanism 228 may include any mechanical and/or electrical system configured to drive operation of components coupled thereto, e.g., assemblies including one or more of a motor (including direct current and/or alternating current motor drives), a power source such as a battery, photovoltaic cell, or external electronic connection, etc. Drive mechanism 228 may enable incremental adjusting of vanes 106 between multiple rotational positions. Where drive mechanism 228 includes a motor, drive mechanism 228 can operate repeatedly in short bursts (i.e., “jogging”) to incrementally rotate fabric supply roller 210. The incremental rotating of fabric supply roller 210 will gradually move second facing 104 relative to first facing 102 to angularly adjust vanes 106 of window shading 100. An operator thus may disable drive mechanism 228 once vanes 106 have adjusted into a desired position.

Friction surface 220, friction roller 222 (where applicable), mechanical coupling 226, drive mechanism 228 may be mounted on or otherwise coupled to a rotatable member 230 for window shading 100. Rotatable member 230 may include, e.g., a rod, shaft, and/or other structural element for mounting of and/or coupling to other components of window shading 100 including casing 112, fabric supply roller 210, etc. Rotatable member 230 member can pivot about and/or rotate concentrically with fabric supply roller 210. In some cases, locking mechanism 224 may be coupled to rotatable member 230 to lock or unlock rotatable member 230 in a selected position. The pivoting and locking action can be accomplished via a combination of gravitational and motor actuated forces or gravitational and clutch operated forces (e.g., via one or more locking mechanisms 224). In still further examples, friction surface 220 and/or friction roller 222 may not be mounted on rotatable member 230 and/or may be operationally independent of rotatable member 230.

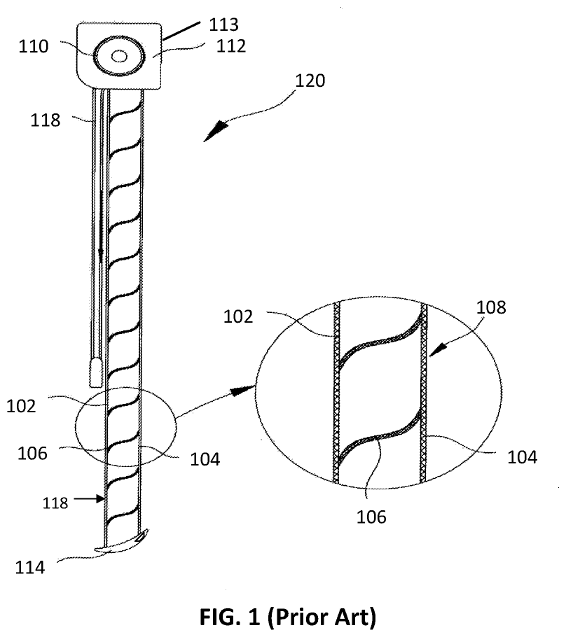

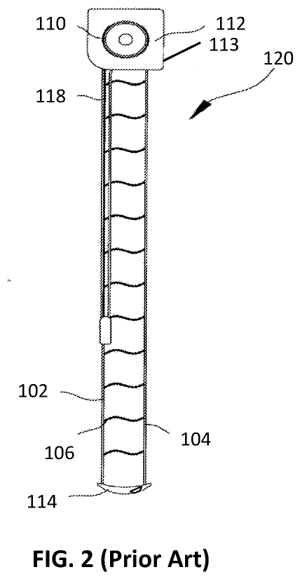

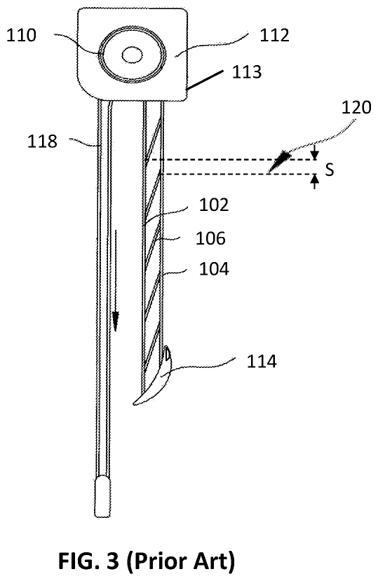

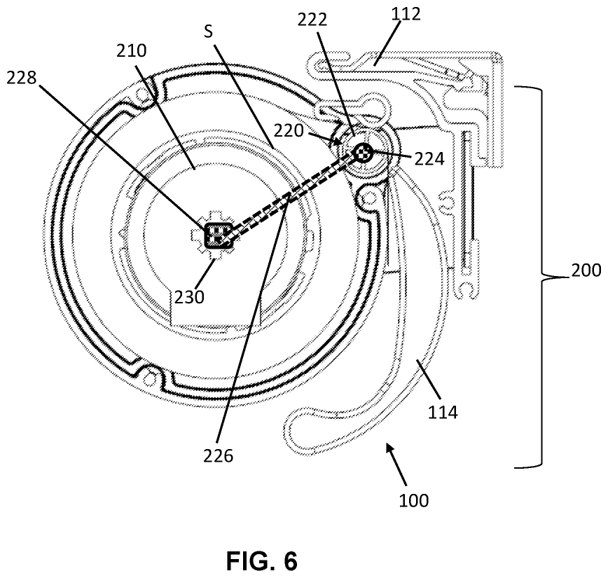

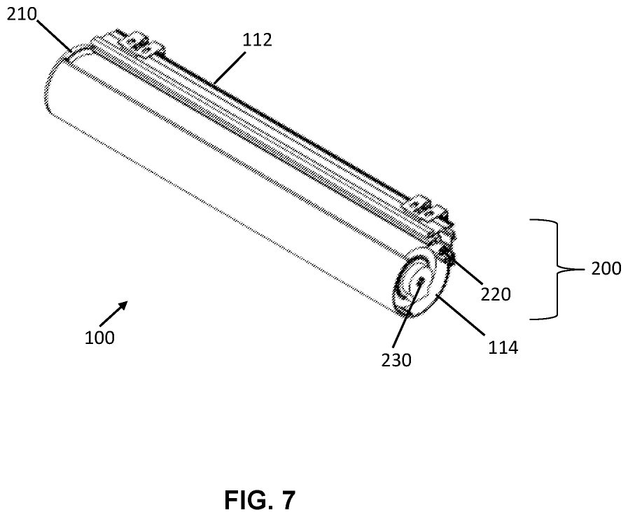

Referring briefly to FIGS. 6 and 7 together, window shading 100 may be capable of operating in substantially the same manner as conventional configurations (e.g., those depicted in FIGS. 1-3), notwithstanding the inclusion of apparatus 200. FIGS. 6 and 7 provide cross-sectional and perspective views, respectively, of how facings 102, 104 may be retracted onto fabric supply roller 210 from the fully deployed position (shown in FIGS. 4, 5). Here, friction surface 220 may impart substantially no opposing friction against first facing 102 as it moves upward, e.g., by rotating in concert with the motion of first facing 102 in the case where friction surface 220 includes friction roller 222. First facing 102 and second facing 104 thus can retract onto fabric supply roller 210, e.g., until bottom rail 114 of window shading 100 is received in casing 112. Thus, window shading 100 may operate substantially as though apparatus 200 and friction surface 220 are not present when facings 102, 104 retract onto fabric supply roller 210 and/or when facings 102, 104 extend to a fully deployed position.

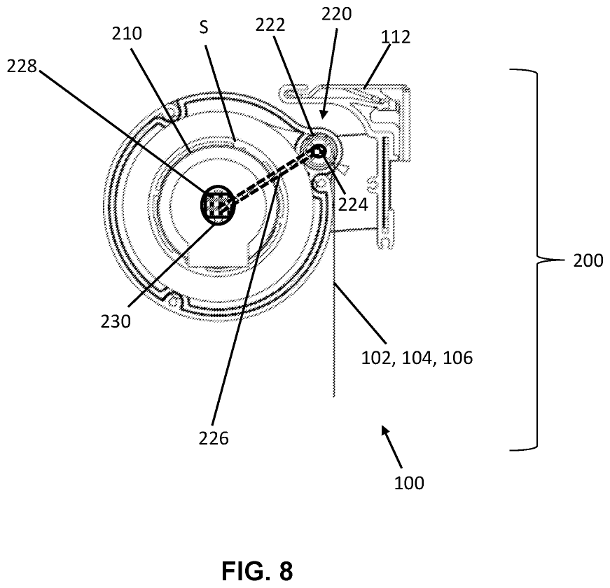

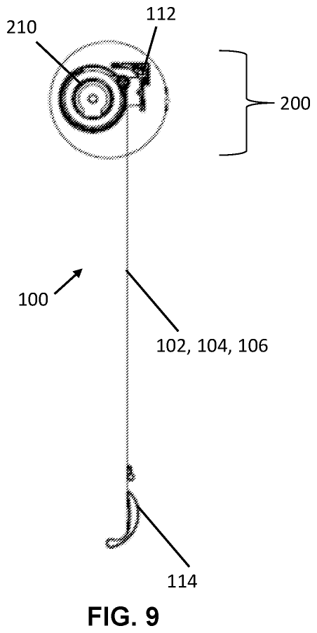

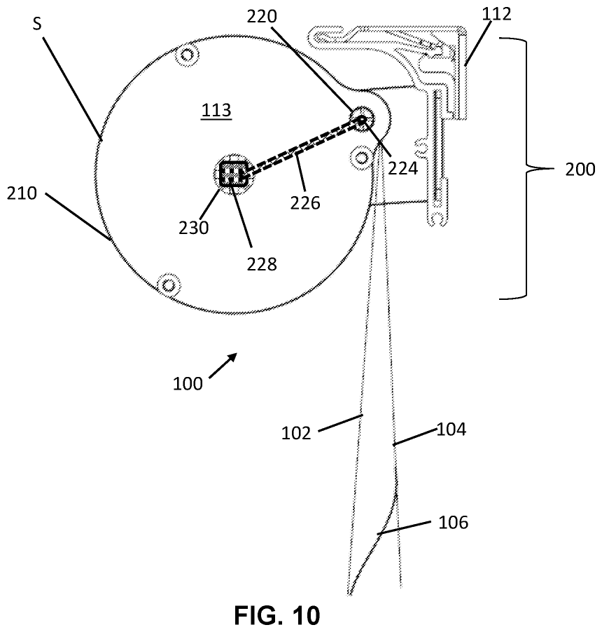

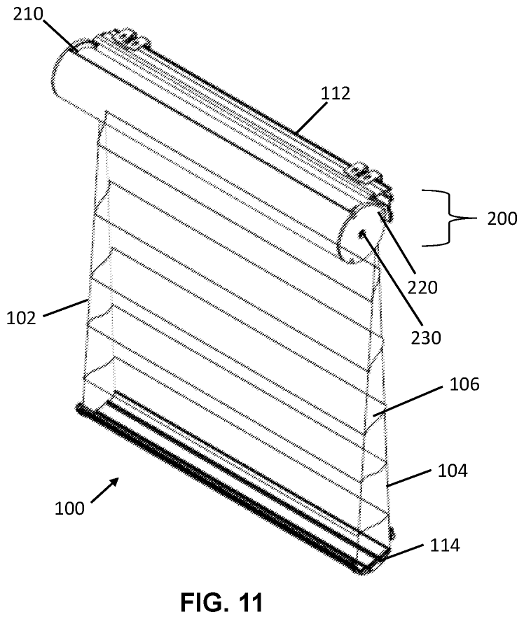

FIGS. 8-11 provide cross-sectional and perspective views of adjusting the angle of vanes 106 via apparatus 200 when facings 102, 104 are not fully deployed from fabric supply roller 210. FIGS. 8 and 9 depict window shading 100 with the vanes in a closed orientation while FIGS. 10 and 11 depict window shading 100 after vanes 106 have opened while facings 102, 104 are only partially deployed. To adjust the angle of vanes 106, friction surface 220 may engage first facing 102 via any of the components and/or methodologies described herein. According to one example, friction surface 220 may move from one position relative to fabric supply roller 210 to another to engage first facing 102. For instance, friction surface 220 is shown in FIG. 4 in a first circumferential position that is below fabric supply roller 210. To engage first facing 102, friction surface 220 (and friction roller 222 where applicable) may move about fabric supply roller 210 to a second circumferential position (e.g., via tracks, bearings, and/or other mechanical couplings on fabric supply roller 210, within casing 112, and/or elsewhere in window shading 100) to engage first facing 102, e.g., by physically contacting first facing 102 as shown in FIG. 8. In further examples, friction surface 220 can engage first facing 102 solely by action of locking mechanism 224.

Engagement between first facing 102 and friction surface 220 causes friction surface 220 to impart frictional force opposing further extension (or alternatively, retraction) of first facing 102 relative to fabric supply roller 210. When facings 102 and 104 are further actuated after engagement of first facing 102 and friction surface 220, friction surface 220 will restrain first facing 102 while second facing 104 continues to move in the intended direction. Thus, second facing 104 will extend (or retract) while first facing 102 remains stationary. As a result, the angular orientation of vane(s) 106 will adjust to another position as second facing 104 moves relative to first facing 102.

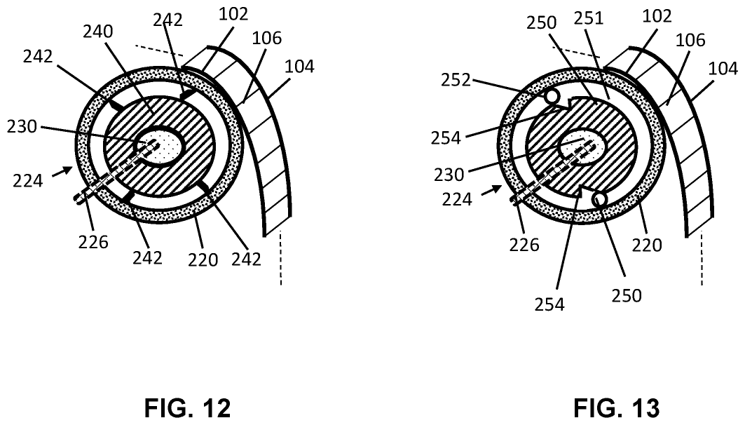

FIGS. 11 and 12 depict side and perspective views, respectively, of window shading 100 after apparatus 200 adjusts facings 102, 104 such that vanes 106 are rotated into an open position. Here, further movement of second facing 104 while first facing 102 is restrained may cause vanes 106 to rotate into a substantially horizontal position such that facings 102, 104 are separated from each other. In this position, facings 102, 104 and bottom rail 114 are not fully deployed from fabric supply roller 210. When second facing 104 is subsequently moved in the opposite direction (e.g., it is retracted after having been extended during restraint of first facing 102), second facing 104 slides over first facing 102 and vanes 106 will return to a vertical orientation (e.g., as shown in FIGS. 8 and 9). Upon reaching this orientation, locking mechanism 224 may allow first facing 102 to move relative to friction surface 220 for further retraction of window shading 100.

Referring to FIGS. 4 and 12 together, embodiments of apparatus 200 include locking mechanism 224 in the form of a sprag clutch 240. Here, friction surface 220 may be a rotatable surface mounted circumferentially about sprag clutch 240. Sprag clutch 240 may include several tangs 242 extending radially from the exterior of sprag clutch to the interior of friction surface 220. Although four tangs 242 are shown as an example, sprag clutch 240 may include only a single tang 242 and/or dozens of tangs 242 or more in various implementations. Tangs 242 may be capable of rotating about sprag clutch 240 in only one direction, e.g., due to gears, ratchets, and/or similar components of sprag clutch 240. Thus, as first facing 102 is subjected to an extension or retraction force in clockwise or counterclockwise directions, tangs 242 may permit movement of first facing 102 in one direction (e.g., rotating during retraction in the counterclockwise direction) while opposing movement of first facing 102 in the opposite direction (e.g., incapable of rotation in the clockwise direction). First facing 102 can move across friction surface 220 when it is raised but is opposed by friction from friction surface 220 when it is lowered, thereby allowing second facing 104 to move relative to first facing 102.

In some cases, sprag clutch 240 may be mounted on rotatable member 230. In still further examples, mechanical coupling 226 may be mechanically coupled to sprag clutch 240 to selectively enable or disable tangs 242 to rotate in a predetermined direction. For instance, sprag clutch 240 may be selectable between two operative states: a first state in which tangs 242 and friction surface 220 may rotate freely in clockwise and counterclockwise directions, and a second state in which tangs 242 and friction surface 220 may rotate in only the clockwise or counterclockwise direction.

Referring to FIGS. 4 and 13 together, further examples of locking mechanism 224 may include a shuttle and track lock 250 for impeding movement of first facing 102 relative to friction surface 220 in only one direction. Shuttle and track lock 250 may include a hollow track 251 shaped to accommodate one or more shuttles 252 (depicted as balls, but also capable of being radial pins, tangs, and/or other moveable elements) therein. Shuttle(s) 252 may move freely in clockwise and/or counterclockwise directions until passing into one or more stops 254 within track 251. FIG. 13 depicts shuttle(s) 252 as entering stop(s) 254 after passing a predetermined distance within track 251. However, track 251 and/or stop(s) 254 alternatively may be shaped to receive shuttle(s) 252 after friction surface 220 undergoes a combination of clockwise and counterclockwise rotations. For instance, track 251 may include alternate pathways that require counterclockwise movement of shuttle(s) 252, with stop(s) 254 being located only in such alternate pathways.

As first facing 102 is subjected to an extension or retraction force in clockwise or counterclockwise directions, shuttle(s) 252 may move within track(s) 251 until entering stop(s) 254. Shuttle(s) 252 being in stop(s) 254 may permit movement of first facing 102 in one direction (e.g., rotating during retraction in the counterclockwise direction) while opposing movement of first facing 102 in the opposite direction (e.g., being incapable of rotation in the clockwise direction), e.g., due to the shape of stop(s) 254 impeding movement of shuttle(s) 252 in one direction. Thus, first facing 102 can move across friction surface 220 when it is raised but is opposed by friction from friction surface 220 when it is lowered, thereby allowing second facing 104 to move relative to first facing 102. In some cases, shuttle and track lock 250 may be mounted on rotatable member 230. In still further examples, mechanical coupling 226 may be mechanically coupled to shuttle and track lock 250 (e.g., to selectively enable or disable stop(s) 254 by mechanically actuated members), thus selectively allowing rotation in a predetermined direction. For instance, shuttle and track lock 250 may be selectable between two operative states: a first state in which shuttle(s) 252 may rotate freely in clockwise and counterclockwise directions, and a second state in which shuttle(s) 252 and friction surface 220 may rotate in only the clockwise or counterclockwise direction.

Embodiments of the disclosure provide a method for operating window shading 100, e.g., to move vanes 106 into various rotational positions before first facing 102 or second facing 104 are fully deployed from fabric supply roller 210. Methods according to the disclosure may include, e.g., engaging first facing 102 of window shading 100 with friction surface 220 to restrain movement of first facing 102. First facing 102 is coupled to fabric supply roller 210 and is coupled to second facing 104 through vanes 106.

Further operation may include rotating fabric supply roller 210 of window shading 100 to extend or retract second facing 104 while engaging first facing 102 with friction surface 220 to adjust an angular position of vanes 106. Engaging of first facing 102 to friction surface 220 may be achieved, e.g., by moving friction surface 220 into a location where it contacts first facing 102, and/or by using locking mechanism 224 to engage first facing 102 with friction surface 220. Methods according to the disclosure may include any one or more corresponding operations and/or techniques described herein regarding various implementations of window shading 100 and/or apparatus 200.

Embodiments of the disclosure may include various technical and commercial advantages, examples of which are discussed herein. Embodiments of the disclosure allow a user to adjust the angular orientation of vanes 106 by moving second facing 104 relative to first facing 102 via apparatus 200. Embodiments of the disclosure can be structurally integrated into a variety of window shading 100 assemblies, including mechanically actuated structures reliant on cords or cordless actuation mechanisms, and/or electronically actuated structures such as motor or battery operated shadings. The use of friction surface 220 may allow a user to interact with window shading 100 in substantially the same manner as if apparatus 200 were not present, while operating the further capability to adjust vane 106 orientation regardless of whether facings 102, 104 are fully deployed from fabric supply roller 210.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. In various settings, one or more operations may be implemented by way of a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

1. An apparatus comprising:
a fabric supply roller having an outer surface;
a window shading including:
a first facing coupled to the fabric supply roller at a first position on the outer surface of the fabric supply roller;
a second facing coupled to the fabric supply roller at a second position on the outer surface of the fabric supply roller; and
a plurality of vanes extending between the first facing and the second facing; and
a friction surface positioned to selectively engage the first facing and restrain substantially downward movement of the first facing during substantially downward movement of the second facing, and to allow substantially upward movement of the first facing during substantially upward movement of the second facing.

2. The apparatus of claim 1, wherein the friction surface is on a friction roller, and the friction roller is operatively coupled to the fabric supply roller.

3. (canceled)

4. The apparatus of claim 1, wherein the friction surface is selectable between:
a first operative state permitting the first facing to move freely; and
a second operative state restraining substantially downward movement of the first facing.

5. (canceled)

6. The apparatus of claim 1, wherein the friction surface is moveable between:
a first position in which the friction surface is disengaged from the first facing to permit the first facing to move freely; and
a second position in which the friction surface engages the first facing to restrain substantially downward movement of the first facing.

7. The apparatus of claim 1, further comprising a locking mechanism coupled to the friction surface and a rotatable member operatively coupled to the fabric supply roller, wherein the friction surface is mounted on the rotatable member, and the locking mechanism selectively prohibits rotation of the rotatable member.

8. (canceled)

9. (canceled)

10. The apparatus of claim 8, wherein the locking mechanism includes a shuttle and track lock.

11. The apparatus of claim 7, wherein the friction surface is operationally independent of the rotatable member and the fabric supply roller.

12. The apparatus of claim 1, wherein the first facing and the second facing are adjustable between a fully retracted position, a fully deployed position, and a plurality of partially deployed positions, wherein the friction surface is configured to selectively restrain movement of the first facing from one of the plurality of partially deployed positions.

13. The apparatus of claim 12, further comprising a motor operatively coupled to the fabric supply roller, wherein the motor is configured to incrementally rotate the fabric supply roller to move the second facing from one of the plurality of partially deployed positions while the friction surface restrains movement of the first facing.

14. The apparatus of claim 1, wherein a material composition of the friction surface imparts a first frictional force on the first facing during retraction of the first facing onto the fabric supply roller and imparts a second frictional force on the first facing during extension of the first facing from the fabric supply roller, wherein the second frictional force is greater than the first frictional force.

15. The apparatus of claim 1, wherein the friction surface is connected to a sprag clutch operatively coupled to the friction surface, and the sprag clutch is configured to selectively prohibit rotation of the friction surface while in contact with the first facing to restrain downward movement of the first facing during rotation of the fabric supply roller.

16. The apparatus of claim 1, wherein the first facing is between the friction surface and the second facing, and the second facing does not contact the friction surface.

17. An apparatus comprising:
a friction surface configured to selectively restrain movement of a first facing of a window shading, the first facing being coupled to a fabric supply roller of the window shading at a first position on an outer surface of the fabric supply roller, and coupled to a second facing of the window shading through a plurality of vanes extending between the first facing and the second facing,
wherein rotating the fabric supply roller of the window shading to extend or retract the second facing, while restraining movement of the first facing with the friction surface, adjusts an angular position of the plurality of vanes.

18. The apparatus of claim 17, wherein the friction surface is selectable between:
a first operative state permitting the first facing to move freely; and
a second operative state restraining substantially downward movement of the first facing, wherein the friction surface is on a friction roller configured to rotate freely in the first operative state and remain stationary in the second operative state.

19. (canceled)

20. The apparatus of claim 17, wherein the friction surface is moveable between:
a first position in which the friction surface is disengaged from the first facing to permit the first facing to move freely; and
a second position in which the friction surface engages the first facing to restrain substantially downward movement of the first facing.

21. The apparatus of claim 17, further comprising a locking mechanism coupled to the friction surface and a rotatable member operatively coupled to the fabric supply roller, wherein the friction surface is mounted on a rotatable member, and the locking mechanism selectively prohibits rotation of the rotatable member.

22. (canceled)

23. A method for operating a window shading, the method comprising:
engaging a first facing of the window shading with a friction surface to restrain movement of the first facing, the first facing being coupled to a fabric supply roller of the window shading at a first position on an outer surface of the fabric supply roller, and coupled to a second facing of the window shading through a plurality of vanes extending between the first facing and the second facing; and
rotating the fabric supply roller of the window shading to extend or retract the second facing while engaging the first facing with the friction surface to adjust an angular position of the plurality of vanes.

24. The method of claim 23, further comprising moving the first facing and the second facing of the window shading to one of a plurality of partially deployed positions before engaging the first facing of the window shading with the friction surface.

25. The method of claim 23, further comprising moving the friction surface to a first position adjacent the roller in which the friction surface is disengaged from the first facing to permit of the first facing to move around the roller, wherein engaging the first facing with the friction surface includes moving the friction surface to a second circumferential position between the roller and the second facing.

26. The method of claim 23, further comprising incrementally extending the second facing from the roller while engaging the first facing of the window shading with the friction surface to incrementally adjust an angular orientation of the plurality of vanes.

27. (canceled)
